(19) United States
(12) Patent Application Publication
(10) Pub. No.: US 2013/0218596 A1
(43) Pub. Date: Aug. 22, 2013

(54) Method And System For Facilitating User Navigation Through A Computerized Medical Information System

(71) Applicant: dbMotion Ltd., (US)

(72) Inventors: Ziv GOME, Beit Kama (IL); Ziv OFEK, Meitar (IL); Robert WARTENFELD, Gealya (IL); Shiri BEN-TAL, Omer (IL); Eyal GREENBERG, Meitar (IL)

(73) Assignee: dbMotion Ltd., Hod Hasharon (IL)

(21) Appl. No.: 13/766,988

(22) Filed: Feb. 14, 2013

Related U.S. Application Data
(60) Provisional application No. 61/599,529, filed on Feb. 16, 2012.

(51) Int. Cl. G06Q 10/06; G06Q 50/22

(52) U.S. Cl. CPC G06Q 10/06; G06Q 50/22
USPC 705/3; 705/2

(57) ABSTRACT

System and method for facilitating clinician-user navigation through a computerized medical information repository including utilizing a clinically ontological hierarchy of clinical semantic elements, the system/method comprising generating an ontology of suggested data requests defined in terms of said ontological hierarchy of clinical semantic elements; and, responsive to an individual clinician-user's navigation through the medical information repository, presenting suggested data requests to the clinician-user based on pre-defined rules defined over the ontology of suggested data requests.

### REFERENCE TO CO-PENDING APPLICATIONS

Priority is claimed from U.S. Provisional Patent Application No. 61/599,529, entitled “Method and/or system for easing user navigation through a computerized medical information system” and filed 16 Feb. 2012.

### FIELD OF THIS DISCLOSURE

The present invention relates generally to IT systems and more particularly to healthcare IT systems.

### BACKGROUND FOR THIS DISCLOSURE

Wikipedia informs that “Apache Lucene is a free/open source information retrieval software library, . . . ported to other programming languages including Delphi, Perl, C#, C++, Python, Ruby, and PHP.[1]. . . . While suitable for any application which requires full text indexing and searching capability, Lucene has been widely recognized for its utility in the implementation of Internet search engines and local, single-site searching. At the core of Lucene's logical architecture is the idea of a document containing fields of text. This flexibility allows Lucene's API to be independent of the file format. Text from PDFs, HTML, Microsoft Word, and OpenDocument documents, as well as many others (except images), can all be indexed as long as their textual information can be extracted. Lucene is . . . an indexing and search library. . . . However, several projects extend Lucene's capability:

“Apache Nutch—provides web crawling and HTML parsing

Apache Solr—an enterprise search server

ElasticSearch—an enterprise search server

Compass—a Java Search Engine Framework

DocFetcher—a multiplatform desktop search application”.

Wikipedia informs that “SNOMED . . . is a systematically organised computer processable collection of medical terms . . . to support the effective clinical recording of data . . . coded in order to be computer processable. It covers areas such as diseases, symptoms, operations, treatments, devices and drugs. . . . It can be used to record the clinical details of individuals in electronic patient records and support application functionality such as informed decision making, linkage to clinical care pathways and knowledge resources, shared care plans and as such support long term patient care. The availability of free automatic coding tools and services, which can return a ranked list of SNOMED CT descriptors to encode any clinical report, could help healthcare professionals to navigate the terminology. . . .

“SNOMED has developed from a pathology-specific nomenclature (SNOP) into a logic-based health care terminology. . . . SNOMED CT cross maps to such other terminologies as ICD-9-CM, ICD-O3, ICD-10, Laboratory LOINC and OPCS-4. It supports ANSI, DICOM, HL7, and ISO standards. . . . SNOMED CT Concepts are representational units . . . which are uniquely identified by a concept ID, i.e. the concept 22298006 refers to Myocardial infarction. All SNOMED CT concepts are organized into acyclic taxonomic (is-a) hierarchies; for example, Viral pneumonia IS-A Infectious pneumonia IS-A Pneumonia IS-A Lung disease. Concepts may have multiple parents, for example Infectious pneumonia is also a child of Infectious disease. The taxonomic structure allows data to be recorded and later accessed at different levels of aggregation.

“SNOMED CT concepts are linked by approximately 1,360,000 links, called relationships. Concepts are further described by various clinical terms or phrases, called Descriptions, which are divided into Fully Specified Names (FSNs), Preferred Terms (PTs), and Synonyms. Each Concept has exactly one FSN, which is unique across all of SNOMED CT. It has, in addition, exactly one PT, which has been decided by a group of clinicians to be the most common way of expressing the meaning of the concept. It may have zero to many Synonyms. . . .

“SNOMED CT can be characterized as a multilingual thesaurus with an ontological foundation. Thesaurus-like features are concept-term relations such as the synonymous descriptions “Acute coryza”, “Acute nasal catarrh”, “Acute rhinitis”, “Common cold” (as well as Spanish “resfrío común” and “rinitis infecciosa”) for the concept 82272006. . . . SNOMED-CT is a class hierarchy (with extensive overlap of classes in contrast to typical statistical classifications like ICD). This means that the SNOMED-CT concept 82272006 defines the class of all the individual disease instances that match the criteria for “common cold” (e.g., one patient may have “head cold” noted in their record, and another may have “Acute coryza”; both can be found as instances of “common cold”). The superclass (Is-A) Relation relates classes in terms of inclusion of their members. That is, all individual “cold-processes” are also included in all superclasses of the class Common Cold, such as Viral upper respiratory tract infection . . .

“SNOMED CT's relational statements are basically triplets of the form Concept₁-Relationₓ-Concept₂, with Relationₓ being from a small number of relation types (called linkage concepts), e.g. finding site, due to, etc. . . . SNOMED CT content . . . operators:
Top, bottom
Primitive roles and concepts with asserted parent(s) for each
Concept definition and conjunction but NOT disjunction or negation
Role hierarchy but not role composition
Domain and range constraints
Existential but not universal restriction
A restricted form of role inclusion axiom (xRŷySz=>xRz)
The logic will be extended in the near future to include General Concept Inclusion Axioms.
   SNOMED CT provides a compositional syntax for building new concepts.”

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

DbMotion healthcare information integration software, being but one example of healthcare IT software, is commercially available. Such software facilitates interoperability and health information exchange (HIE) for health information networks and integrated healthcare delivery systems.

Certain embodiments of the present invention seek to provide caregivers and information systems secure access to an integrated patient record composed from the patient's medical data maintained at facilities that are otherwise unconnected or have no common technology through which to share data. The solution is operative for serving as many as millions of patients and integrating as many as billions of individual records of clinical information.

One of the emerging problems in today's clinician interaction with electronic patient information is the information flood. Several processes contribute to this “too much information” syndrome including the amount of information collected in electronic systems, the ability to share patient information and the ever-decreasing clinician's time allotted for each patient visit.

Certain embodiments of the present invention seek to provide computerized functionality for significantly improving a clinician's ability to quickly locate and digest the relevant information in the patient's chart, typically including functionality to:
Provide clinicians with tools with which they could quickly and intuitively find information and/or
Present the information in such ways that are intuitive to clinicians.

Certain embodiments of the present invention seek to provide a computerized system for displaying clinical information. Conventional clinical information systems may use table-based or tree-based views which are based on the structure of the data, but do not fit the task the clinician has in mind or what he/she may look for. A particular feature of certain embodiments is that a task or goal of a human user is anticipated and at least one view of the data is provided accordingly, rather than providing a view of the data which merely reflects the data's logical structure.

An advantage of certain embodiments herein is the ability to elicit from a clinician-user, data which allows the system to “follow the clinician's mind” and return a suitable response accordingly, typically following associative links, also termed herein “associative relationships” in addition to standard navigation techniques.

This may be achieved by employing one some or all of the following techniques:
1. Search
   The user inputs a search phrase, such as “diabetes” and all the relevant information around diabetes management is immediately presented as the user types.
   This may be achieved by putting together any or all of several techniques as elaborated below.
2. Questions & Answers
   Among the results of the search may be not only information items, but also questions that the user may have in mind. For example, when searching for “diabetes”, the user has some task in mind, typically related to some question s/he is looking for an answer to, such as “Is the patient's Diabetes state controlled?”. There may be several ways to answer such a question, such as some or all of:
   a. A table containing carefully selected data elements from the patient record, such as specific laboratory results that serve as diabetes indicators.
   b. A graph of Hemoglobin A1C tests over time, showing acute Vs Chronic state.
   c. Diabetic medication history graph, designed for this purpose.
   d. A conclusion deduced by rule engine based on the patient information.
   The example above shows how the system may adapt to the user's needs, saving significant clinician time to be used for patient care. By following the clinician's line of thought, the system and/or human experts may build answers to clinicians' day-to-day frequently asked questions.
   Questions do not have to be patient-centric. Other kind of questions can be added to the system such as “How can I improve in Diabetes Care”—an example of a question from the population health and analytics domains.
   Typically, a Questions & Answers library is provided which is typically manageable to allow clinicians to plug in more questions and answers as they see fit.
3. Associative Exploration including provision of “you may also want to know”-type answers: As the user looks through patient's file, the system typically makes further exploration topic suggestions to the user as that are relevant specifically in the patient context and the user goals. These may include, among others, suggested views from the Questions & Answers library. Such exploration topic suggestions may arise for example from patient data itself, from a current view, or from a combination of the two.
   The term “associative” e.g. facilitation of user associative navigation through a computerized medical information system, “associative relationships”, “associative links” and the like, involves relationships between elements in an ontology that originate from a human's line of thought rather than from hard facts or data. Such relationships may be generated and/or maintained by a knowledge engineer and may be suggested to a clinician at run-time. For example, the questions “Has patient seen a dietitian?” and “is Patient filling her or his Diabetes prescriptions?” would not be considered related in conventional health-care IT systems, however, a clinician thinking in terms of compliance and lifestyle would be well served if the system is operative for suggesting the latter topic to a user viewing the first topic. Also, topics from different diseases—say CHF and Diabetes—may not generally be related but may be associatively related e.g. in the context of a patient suffering from both.

Alternative or cumulative schemes e.g. in order to achieve the above described objectives, are described in detail herein.

The present invention typically includes at least the following embodiments:

Embodiment 1. A method and/or system for facilitating user navigation through a medical information system, the system including:

retrieving, prioritizing and presenting to the user, a plurality of possible questions and other exploration topics from a suitable knowledge base;

accepting a user's selection of an individual question from among the plurality of possible questions; and

changing information displayed to the user, responsive to the user's selection.
Embodiment 2. A method and/or system according to Embodiment 1 wherein said changing includes terminating display of at least one information item previously displayed, responsive to said user's selection.
Embodiment 3. A method and/or system according to Embodiment 1 said changing includes displaying information pertaining to a user-selected patient, responsively to said individual question.
Embodiment 4. A method and/or system according to Embodiment 3 wherein the information pertaining to a user-selected patient is selected from among a repository of information available regarding the user-selected patient, using previously stored knowledge regarding relevance of said information to said individual question.
Embodiment 5. A method and/or system according to Embodiment 3 wherein the information pertaining to a user-selected patient is formatted using an individual format, selected from among a library of formats using previously stored knowledge regarding suitability of said format to said individual question.
Embodiment 6. A method and/or system according to Embodiment 5 wherein said format comprises a graph.
Embodiment 7. A method and/or system according to Embodiment 5 wherein said format comprises a table.
Embodiment 8. A method and/or system according to any of the preceding Embodiments which is implemented as an application integrated into a larger-scope clinical system and which responds to the clinician context of that application e.g. by receiving as input:

user and/or patient details, and

a term representing a clinician workflow context and responding with a context based answer.
Embodiment 9. A method and/or system according to any of the preceding Embodiments and also comprising receiving a user's search request and using the user's search request for retrieving, prioritizing and presenting to the user, a plurality of possible questions and other exploration topics.
Embodiment 10. A method and/or system as described herein combined with any method and/or system described in co-pending published US Patent Application No. 20110288877.
Embodiment 11. Search-based navigation in clinical patient record(s) utilizing utilize semantic properties of a clinical ontology (say, for example, Snomed, RxNorm or NDC) for boosting, as described herein with reference to semantic search.

Boosting is a method for modifying search results using criteria that an original, legacy computerized search functionality is ignorant of. Boosting may for example comprise defining a multiplicative factor that multiplies the score of a searchable element (“document”), either increasing or decreasing the search score. Boosting can be performed at any or all of several levels, at indexing time (boost factor for the document or field) or at search time (boosting the term). Boosting may be implemented in Lucene technology, inter alia.

Those semantic properties of a clinical ontology may include (among others), some or all of:
a. Concept's built in synonyms
b. Type of concept
c. Concepts location in the hierarchy, for example, height in the ontology forest
d. Number of mapped concepts
e. Frequency of usage of the concepts—as specified by the terminology publisher, or based on actual usage statistics within a clinical organization.
Embodiment 12. Search-based navigation in clinical patient record(s) utilizing a combination of semantic search and free text, which compensate for one another.
Embodiment 13. Exploration of clinical patient record based on a knowledge base of exploration topics which is stored in computer memory as an extensible ontology which may be expanded or added on to, e.g. by human experts. A useful pattern for these exploration topics is questions and answers provided responsive to selected ones from among the questions.
Typically, the system utilizes a design-time mode, in which users—knowledge engineers—are entitled to extend and configure the ontology knowledge base by adding more exploration topics thereto or by adjusting existing elements therein.
An example of a disease exploration ontology knowledge base is shown in FIG. 18.
Typically, all elements expect the patient.
In a Disease Exploration Ontology, typically, content is organized in computer memory so as to facilitate efficient application to patient data. For example, elements from a clinical ontology in which patient data is expressed may be incorporated into the content. This allows a two-way-relationship between content—suggested data requests—and patient data. Looking up suggestions relevant to patient data being viewed is facilitated, e.g. by moving up the clinical ontology from key elements in the patient data, such as a problem list, and intersecting with the Disease Exploration ontology. Also, suggested data requests may be expressed in terms of the clinical ontology, facilitating application to patient data. For example—medications shown may be limited to “beta blockers”—an intermediate-level clinical ontology concept which may be an “ancestor”, in the ontology, of hundreds of possible variations of medications.
Typically, the system utilizes runtime mode in which the system is integrated into an electronic clinical patient record and can so be used in the context of a patient. In that mode the system allows users—clinicians e.g.—to search through the exploration topic ontology, and suggests search-related exploration topics, for example questions, and presents relevant answers (responses) extracted from the ontology knowledge base. The results—for example answers—are applied to the individual patient viewed by the clinician.
Typically, the exploration topics ontology is interconnected with the clinical ontology (say, for example, SnoMed) by which the patient record is expressed, and is constructed and operative such that the system is operative to create associative relationships given a patient context. For example, when user looks at a typically system-provided question about some chronic disease management, say “is CHF controlled?”, the patient at hand may have other chronic conditions, such as Diabetes. So, the system may suggest diabetes-related exploration topics whose “flavor” is similar to the CHF question currently viewed. The system may refrain from suggesting same for a non-diabetic patient for whom this is not relevant. Similarly, the system may refrain from suggesting exploration topics, or views, that are not of similar nature to the current exploration topic (CHF question)—chronic disease management.
The embodiments shown and described herein are particularly useful in the context of or in conjunction with medical informatics systems such as the dbMotion™ systems which typically facilitate Interoperability and Health Information Exchange (HIE) for integrated healthcare delivery systems and health information networks, integrating medical information from across a continuum of care-providing computerized systems, e.g. by leveraging a Service Oriented Architecture (SOA).
Also provided, excluding signals, is a computer program comprising computer program code means for performing any of the methods shown and described herein when said program is run on a computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a typically non-transitory computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein, such as but not limited to steps of flowcharts, may be performed by a conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor may be employed to compute or generate information as described herein e.g. by providing one or more modules in the processor to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following (UML) drawings:

FIG. 1 is a diagram of Disease Exploration Use Cases; some or all of the illustrated elements may be provided according to certain embodiments of the present invention.

FIG. 2 is a diagram of Disease Exploration Components; some or all of the illustrated elements may be provided according to certain embodiments of the present invention.

FIG. 3 is a diagram of Manage Disease Exploration Ontology Knowledge Base UC (use case) Implementation; some or all of the illustrated elements may be provided according to certain embodiments of the present invention.

FIG. 4 is a diagram of a method operative to Explore Patient Record—UC (use case) Implementation; some or all of the illustrated elements may be provided according to certain embodiments of the present invention.

FIG. 5 is a diagram of a method operative to Ask Question—UC (use case) Implementation; some or all of the illustrated elements may be provided according to certain embodiments of the present invention.

FIG. 6 is a diagram of a method operative to Search In Patient Record UC (use case) Implementation; some or all of the illustrated elements may be provided according to certain embodiments of the present invention.

FIG. 7 is a diagram of a method operative to Follow Exploration Topic Suggestions—UC (use case) Implementation; some or all of the illustrated elements may be provided according to certain embodiments of the present invention.

FIG. 8 is a diagram of a VPO Explorer Mode with no search topics; some or all of the illustrated elements may be provided according to certain embodiments of the present invention.

FIG. 9 is a diagram of a VPO Explorer Mode with User types, where Suggestions Appear; some or all of the illustrated elements may be provided according to certain embodiments of the present invention.

FIG. 10 is a diagram of a VPO Explorer Mode with Filtered Patient Record, some or all of the illustrated elements may be provided according to certain embodiments of the present invention.

FIG. 11 is a diagram of a Question Mode with No Search; some or all of the illustrated elements may be provided according to certain embodiments of the present invention.

FIG. 12 is a diagram of a Questions Mode where Relevant Questions Appear and No Question is Selected; some or all of the illustrated elements may be provided according to certain embodiments of the present invention.

FIG. 13 is a diagram of a Questions Mode—Question Selected, Answer Presented; some or all of the illustrated elements may be provided according to certain embodiments of the present invention.

FIGS. 14-17 are tables, some or all of the cells, rows and columns of which may be provided, which are useful in understanding certain embodiments of the present invention.

FIG. 18 presents a method for deducing further exploration topics (question and answers, in the illustrated embodiment) e.g. by navigating from one topic or question to other questions related to the patient, all according to certain embodiments of the present invention.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

There is thus provided, in accordance with certain embodiments, a method for facilitating clinician-user navigation through a computerized medical information repository including utilizing a clinically ontological hierarchy of clinical semantic elements, the method comprising:

generating an ontology of suggested data requests defined in terms of said ontological hierarchy of clinical semantic elements; and

Responsive to an individual clinician-user's navigation through the medical information repository, presenting suggested data requests to the clinician-user based on pre-defined rules defined over the ontology of suggested data requests.

For example, the ontology of suggested data requests might include “What medications is patient taking to alleviate constipation?”, “What medications is patient taking to alleviate headache?” and “What medications is patient taking to alleviate fever?”, all of which may be “siblings”, and “sons” of a data request template such as “What medications is patient taking to alleviate [symptom}?”. These ontological relations within the ontology of suggested data requests are defined in terms of the ontological hierarchy of clinical semantic elements which might define constipation, headache and fever as siblings having a common father: symptom. To give another example, the ontology of suggested data requests might also include “Has the patient reported any improvement in her/his constipation?”, “Has the patient reported any improvement in her/his headache?” and “Has the patient reported any improvement in her/his fever?”, all of which may be “siblings”, and “sons” of a data request template such as “Has the patient reported any improvement in her/his [symptom}?”. It is appreciated that chronic disease, management of which is a huge effort, can be facilitated similarly by converting a conventional healthcare IT system into one with information request suggestion functionality, and/or with an ontology of information requests as described above.

One rule might be that if a suggested data request is presented and is selected by the clinician-user, present to the clinician-user all suggested data requests having a predefined ontological relationship (such as “sibling”) to the selected suggested data request, in the ontology of data requests. This may be specific to a patient e.g. all siblings which exist within an individual patient record. For example, John Smith has reported headache and fever, so if a suggested data request: “Has the patient reported any improvement in her/his headache?” is selected by the clinician-user, the system may present “Has the patient reported any improvement in her/his fever?” to the clinician-user but not “Has the patient reported any improvement in her/his constipation?” which is not relevant to John.

Each suggested data request may for example comprise or be presented as a question, such as “What medications is patient taking to alleviate constipation symptom?”. The term “suggested data request” is used herein to include any request for any sort or type of response which may include any sort or type of data such as but not limited to various views of given computerized medical information, various formats of presentation for same computerized medical information such as various graphs, tables, animations, sound-effects, alerts and diagrams, and various scopes or resolutions or other arrangements or subsets or derivatives or combinations of given computerized medical information. The term “exploration topic” or “topic” is used herein generally synonymously with the term “suggested data request”.

Further, in accordance with certain embodiments, the method also comprises:

Responsive to an individual clinician-user's navigation through the medical information repository, thereby to define a current user location disposed within the medical information repository and pertaining to at least one individual related element within said clinically ontological hierarchy of clinical semantic elements:
from among a multiplicity of suggested data requests, selecting at least one individual suggested data request which is defined in terms of an ancestor of an individual son-element within said clinically ontological hierarchy of clinical semantic elements,
plugging medical information pertaining to said individual son-element into said suggested data request thereby to generate a son-specific suggested data request, and
presenting the son-specific suggested data request to the clinician-user, and

Responsive to a clinician-user's selection of an individual son-specific suggested data request from among those presented: presenting, to the clinician user, at least one response to said individual son-specific suggested data request.

For example, “chronic condition” may be a father semantic element in an ontology used in a computerized medical information repository such as an HIE (health information exchange) and “CHF” and “diabetes” are two of that father's sons—each of which may or may not be relevant for a particular patient. Examples of a user location disposed within a medical information repository are: a certain page, such as Bloodwork or Medications, within John Smith's patient record; or a certain page within a public health record such as the Inoculations page or Reported Injuries page. An example suggested data request is: IS {CHRONIC CONDITION} CONTROLLED? Plugging medical information into the suggested data request to generate a son-specific suggested data request might yield: IS CHF CONTROLLED? Or: IS DIABETES CONTROLLED?
The system need not automatically generate such topics, and may instead be pre-defined, e.g. by humans, to include relevant views to such topics which may be maintained by knowledge engineers.

It is appreciated that the ontological relationship which fuels generation of related suggested data requests does not have to be a father-son or ancestor-descendant relationship. More generally, any other pre-defined ontological criterion fueling generation of related suggested data requests, e.g. as described herein, may be employed.

Still further in accordance with certain embodiments, the method also comprises, responsive to a clinician-user's selection of an individual son-specific suggested data request from among those presented, plugging individual medical information pertaining to an additional son-element of said ancestor into said individual suggested data request thereby to generate at least one additional son-specific suggested data request instance, and presenting the additional son-specific suggested data request instance to the clinician-user.

For example, a clinician-user might select IS CHF CONTROLLED? For a certain patient, and later go to the section of a patient's (the same patient's, or another patient's) health record which pertains to diabetes. At this point, the system may plug DIABETES into IS {CHRONIC CONDITION} CONTROLLED? thereby to generate and present to the clinician-user, an additional son-specific suggested data request instance namely IS DIABETES CONTROLLED?

Additionally in accordance with certain embodiments, the current user location is located within an individual patient record within the computerized medical information repository and wherein the additional son-element is selected to be a son-element which is defined for said ancestor within said individual patient record.

For example, a clinician-user might select IS CHF CONTROLLED? for a certain patient who suffers from CHF and also from diabetes and 2 other chronic conditions. In this case, the system may plug DIABETES into IS {CHRONIC CONDITION} CONTROLLED? thereby to generate and present to the clinician-user, 3 additional son-specific suggested data request instances for his or her possible selection namely IS DIABETES CONTROLLED? And similar for the 2 additional chronic conditions afflicting this individual patient.

Further in accordance with certain embodiments, responsive to the individual clinician-user's selection of said individual suggested data request, a plurality of responses to said individual suggested data request are presented to the clinician user corresponding to a plurality of pre-defined response formats respectively.

For example, response formats may include graph-archetypes, report-archetypes, or table-archetypes—into which available clinical information about at least one individual patient is plugged so as to represent available clinical data in selectable different ways.

Still further in accordance with certain embodiments, the method also comprises receiving the individual clinician-user's selection of an individual response, from among the plurality of responses, which is formatted according to an individual response format from among the plurality of pre-defined response formats; and

learning the individual clinician-user's expected response to at least one suggested data request including: upon future selection by the individual clinician-user, of a suggested data request instance of the same individual suggested data request, prioritizing presentation of a response formatted according to the individual response format previously selected by the individual clinician-user, over presentation of responses formatted according to response formats other than the individual response format previously selected by the individual clinician-user.

For example, a clinician-user's selects a pie-chart format, rather than various other pre-defined response formats such as histograms, to represent data regarding levels of blood pressure readings per day, upon future selection by the individual clinician-user, of a suggested data request instance of the same individual suggested data request, the pie-chart format option may be presented first (top of the response format menu) whereas histogram formats may be presented only lower on the response format menu.

Further in accordance with certain embodiments, the method also comprises pre-generating a multiplicity of suggested data requests; and pre-generating responses including at least one response for each of the multiplicity of suggested data requests respectively.

Additionally in accordance with certain embodiments, presenting comprises some or all of the following:

Responsive to an individual clinician-user's navigation through the medical information repository:
selecting at least one individual suggested data request from among the multiplicity of suggested data requests for presentation to the clinician user; and
presenting, to the clinician user, a plurality of responses to said individual suggested data request corresponding to a plurality of pre-defined response formats respectively;

Receiving the individual clinician-user's selection of an individual response, from among the plurality of responses, which is formatted according to an individual response format from among the plurality of pre-defined response formats; and

learning the individual clinician-user's expected response to the at least one suggested data request including: upon future selection by the individual clinician-user, of a suggested data request instance of the same individual suggested data request, prioritizing presentation of a response formatted according to the individual response format previously selected by the individual clinician-user, over presentation of responses formatted according to response formats other than the individual response format previously selected by the individual clinician-user.

Still further in accordance with certain embodiments, the method also comprises pre-generating the multiplicity of suggested data requests.

Still further in accordance with certain embodiments, the method also comprises pre-generating responses including at least one response for each of the multiplicity of suggested data requests respectively.

Further in accordance with certain embodiments, the clinically ontological hierarchy of elements includes at least one of:

a SNOMED-based clinically ontological hierarchy of clinical semantic elements;

a LOINC-based clinically ontological hierarchy of clinical semantic elements;

an RxNorm-based clinically ontological hierarchy of clinical semantic elements; and

an NDC-based clinically ontological hierarchy of clinical semantic elements.

Still further in accordance with certain embodiments, pre-generating is characterized to facilitate:

responsive to an individual clinician-user's navigation through the medical information repository, thereby to define a current user location disposed within the medical information repository and pertaining to at least one individual son-element within said clinically ontological hierarchy of clinical semantic elements:
Selection of at least one individual suggested data request from among the multiplicity of suggested data requests which is defined in terms of an ancestor of said son-element within said clinically ontological hierarchy of clinical semantic elements,
Plugging of medical information pertaining to said individual son-element into said suggested data request thereby to generate a son-specific suggested data request, and
Presentation of the son-specific suggested data request to the clinician-user.

Further in accordance with certain embodiments, pre-generating is also characterized to facilitate, responsive to a clinician-user's selection of an individual son-specific suggested data request from among those presented: presentation, to the clinician user, at least one response to said individual son-specific suggested data request.

Still further in accordance with certain embodiments, said ontology of suggested data requests is also defined so as to ontologically relate data requests pertaining to aspects of patient compliance even if the ontological hierarchy of clinical semantic elements does not ontologically relate clinical semantic elements pertaining to patient compliance.

Additionally in accordance with certain embodiments, said ontology of suggested data requests is also defined so as to ontologically relate data requests pertaining to aspects of patient life-style even if the ontological hierarchy of clinical semantic elements does not ontologically relate clinical semantic elements pertaining to patient life-style.

An example computerized system operative for performing some or all of the above methods, is now described in detail.

Examples of System Use Cases, some or all of which may be provided, are now described.

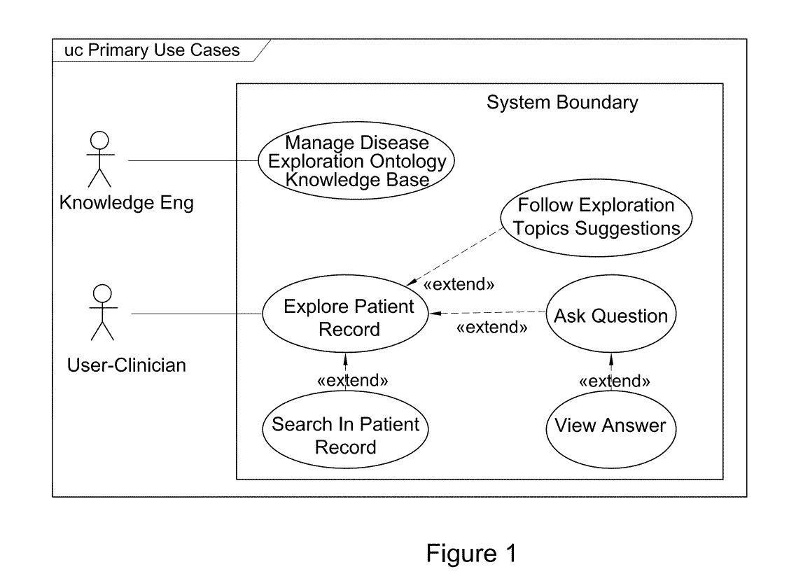

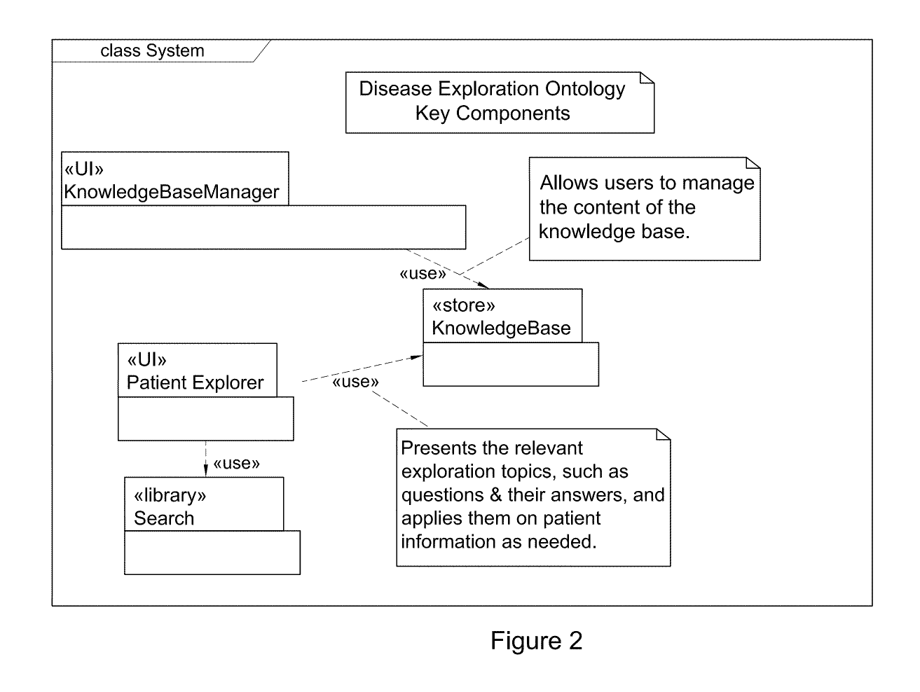

FIG. 1 illustrates Disease Exploration Use Cases. Some or all of the following may be provided:
a. Manage Disease Exploration Ontology Knowledge Base: The system allows knowledge engineers to effect some or all of the following operations: change properties of questions, such as which is the default answer; add new questions, and assign answers thereto; register new types of pluggable exploration topic view templates, also termed herein “view templates”, to be used as answers and more. Examples of pluggable exploration topic view templates include:
1. A graph which shows Laboratory results together with medication dosage over time, including interaction therebetween. The parameters that make the graph into a template may be: which labs types and which medications should be viewed; these may be chosen per disease.
2. Grid views of data elements related to a disease, including for example immunizations, labs, problem list, medications and encounters. The template may expose a set of types or codes of relevant data elements—set differently per disease.
3. Disease summary view—may not even be a template; instead may be a custom-made view for the specific disease at hand, including some or all of: relevant computed scores, key indicators and latest visits to relevant clinicians such as, say, cardiologists, physical therapist, dietitians.
b. Explore Patient Record: The system presents patient clinical data to care provider in effective, intuitive and associative ways. These may include some or all of the following:
i. Search Patient Record: The system allows the clinician (the user) to search within the patient record and within clinical documents in the patient record. The search may include: semantic search in coded data or free text fields, search in time fields or a combination of all or some of the above.
ii. Ask Question: typically, the system allows the clinician (the user) to ask questions to which she seeks answers for. Questions may have one or more answers, and may be stored in computer memory in association with related questions.
   iii. View Answer: The system presents the user with relevant answer(s) to the question. These answers may for example include parameterized views (e.g. view templates), pages, graphs and more. The system strives to present the relevant information the user needs to know in the context of an individual question. However, to make it feasible to support many diseases it is inefficient for human developers to develop (and test and so on) specific presentations for each disease. Thereby the template, with its disease-oriented parameters is a suitable solution. A clinical ontology has in-place hierarchies and other relations that allow a small number of information requests to be formulated in template form which span much greater numbers of instances of information requests once specific parameters are plugged into the template. In medication for example a specific ingredient can be found in thousands of medications, each having a code, provided by different manufacturers and in different dosage. A particular advantage of certain embodiments is that it is not necessary to name each such code separately when information is requested re medications that include that ingredient.
iv. Follow Exploration Topics Suggestions: The system presents the user with further relevant exploration topics such as questions and answers, based on a disease exploration ontology knowledge base. The method for selecting the suggestions may for example include some or all of:
   a. Different answers to the question asked.
   b. Other questions relating to the question asked
   c. Further exploration topics, emerging from the patient clinical data e.g. as expressed in a clinical ontology, interconnected with the disease exploration ontology.
      An example of a suitable System Design Model is now described in detail.
Search Capabilities: Conventional dbMotion and other similar healthcare IT products have search capabilities and, e.g. in dbMotion products, semantic searches in particular, which may be applied to a patient record. However, the relevant use cases' implementation diagrams reference search packages as appropriate to illustrate their role.
Questions & Answers: The system may include of some or all of the Disease Exploration components shown in FIG. 2.

The Knowledge Base of FIG. 2 is now described, according to certain embodiments: In this component the system typically stores and manages various elements of a Disease Exploration Ontology, such as exploration topics e.g. questions, views that serve as answers and more. Some or all of query, search, add, edit & remove functionalities are provided.

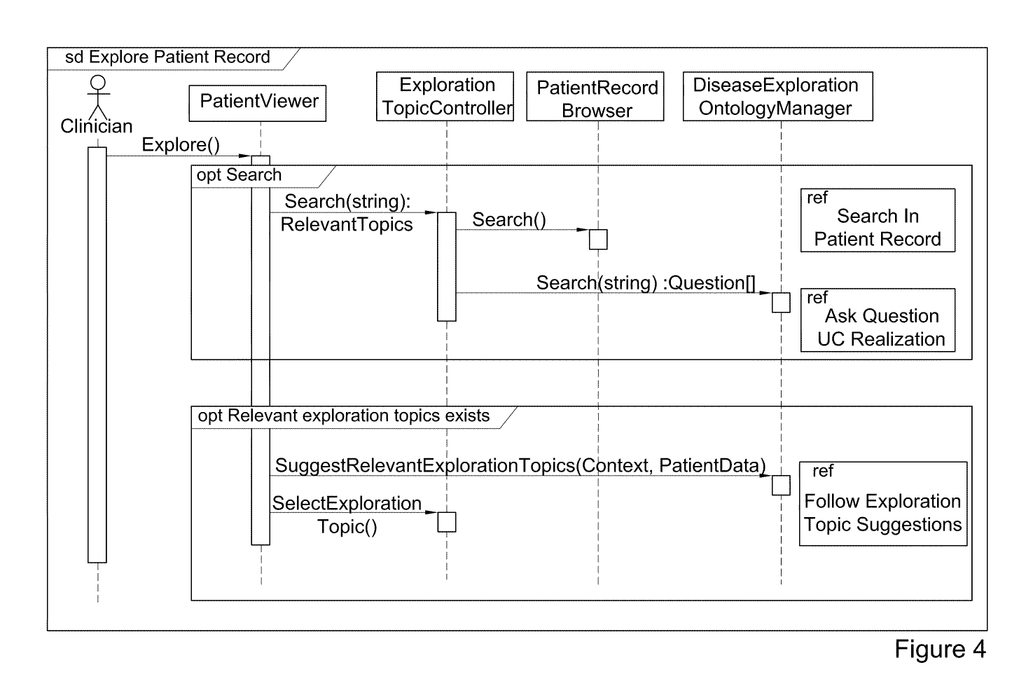

The Patient Explorer of FIG. 2 is now described, according to certain embodiments: A User-Interface (UI) application is operative to present acquired exploration topics, such as questions and answers, to clinicians at the point of care. This application may also be integrated into a larger-scope clinical system and may respond to the clinician context of that application, e.g. by receiving as input not only user and patient details, but also a term representing a clinician workflow context (e.g. “hemoglobin”) and responding with a context based answer. This application type capitalizes on some or all of: the disease exploration ontology knowledge base, on the patient record, and on relevant presentation methods. It typically supports a pluggable mechanism to allow further view templates to be added as appropriate.
The Patient Explorer of FIG. 2 typically capitalizes on some or all of: the disease exploration ontology knowledge base, on the patient record, and on relevant presentation methods, e.g. using the methods of the sequence diagrams of FIGS. 4-7; these figures illustrate a sequence of operations, some or all of which may be performed, suitably ordered e.g. as shown. It is appreciated that the following may be respectively synonymous: “Patient Explorer” and “Patient Viewer”; “KnowledgeBase” and “Disease Exploration Ontology Manager”. Typically, the Patient Explorer of FIG. 2 supports a pluggable mechanism to allow further view templates, e.g. as described herein, to be added as appropriate.

The Knowledge Base Manager (Editor) of FIG. 2 is now described, according to certain embodiments: The Knowledge Base Manager typically comprises a User-Interface (UI) application in which users may change the contents of the Disease Exploration Ontology Knowledge Base, e.g. may change properties of questions, such as which is the default answer; add new questions, and assign answers thereto; register new types of pluggable exploration topic view templates to be used as answers and more.

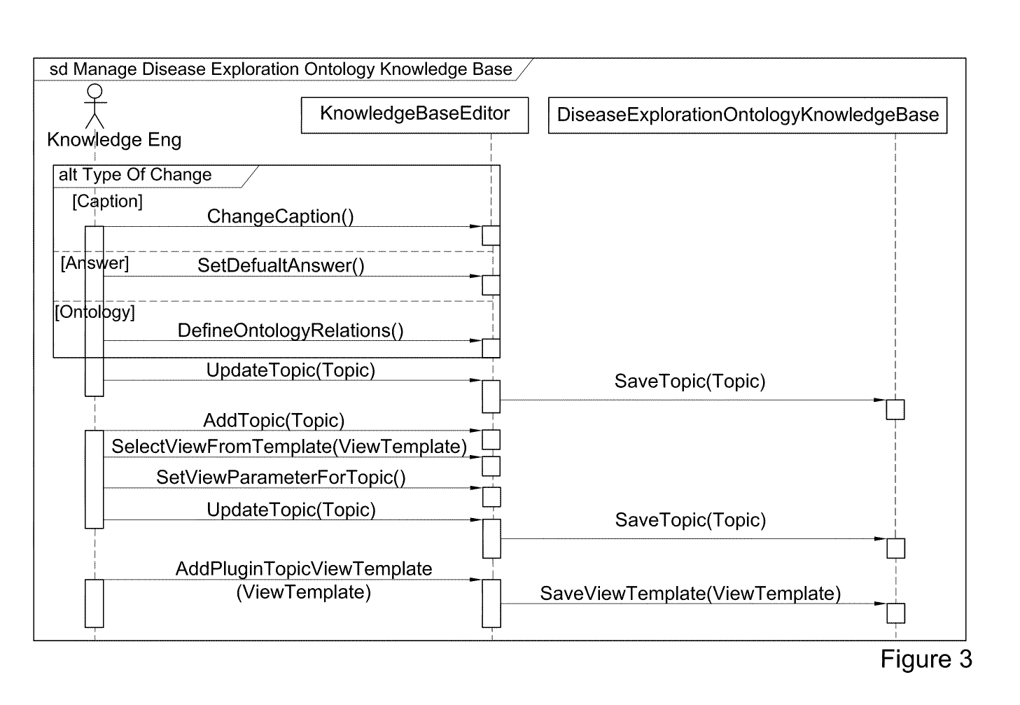

An example Use Case Implementation method, allowing the system to implement, e.g., the above-described use cases, is now described.
Manage Disease Exploration Ontology Knowledge Base: FIG. 3 presents how the system may implement different knowledge base use case implementation scenarios.

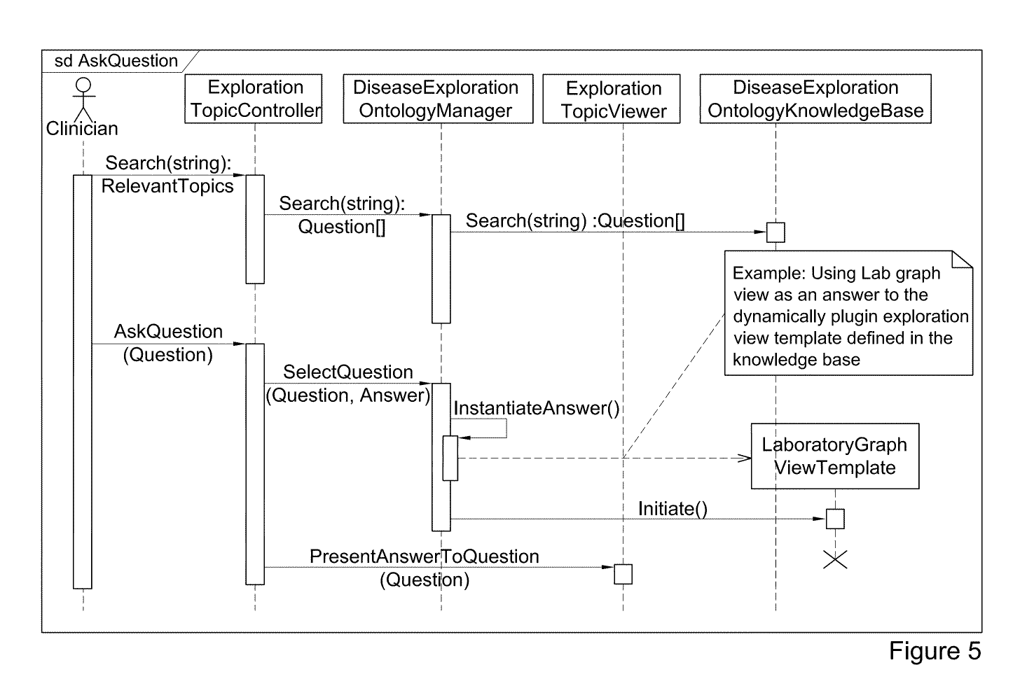

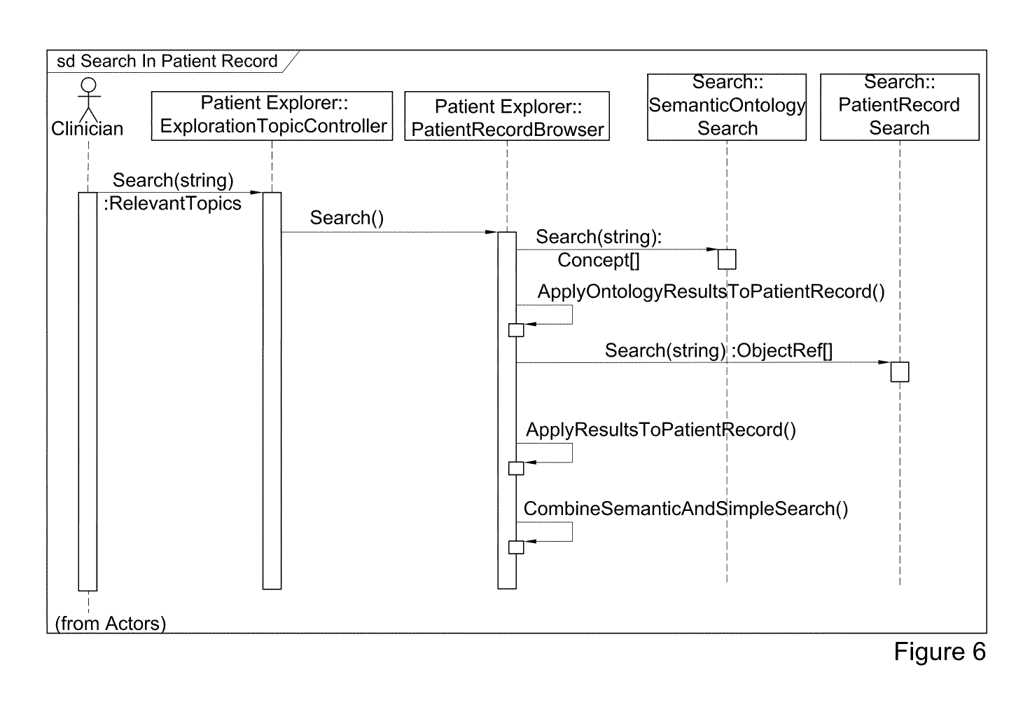

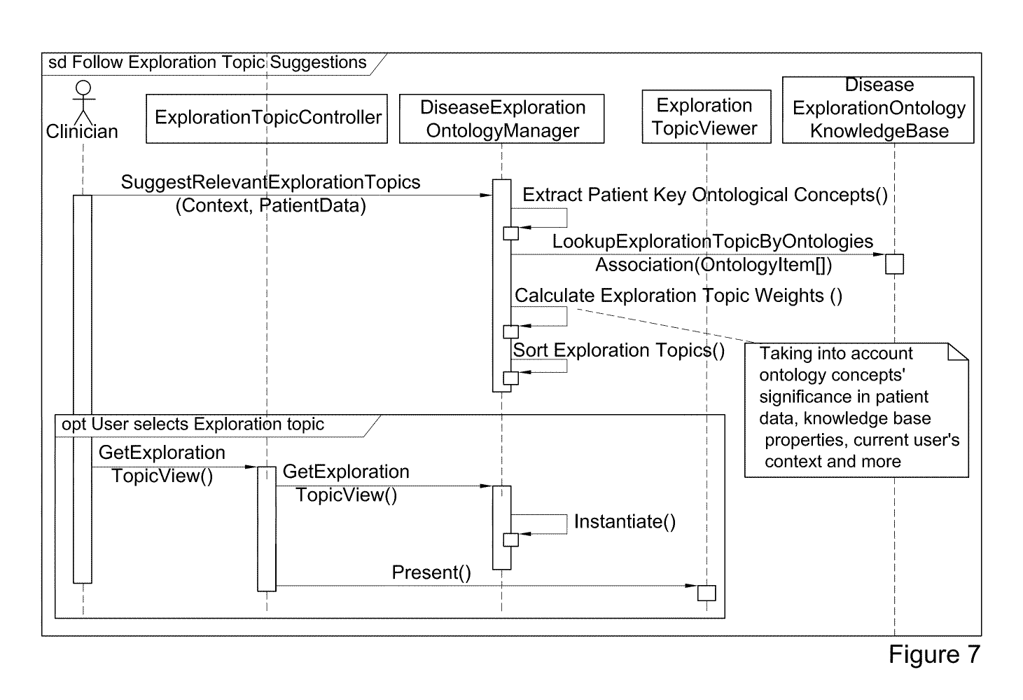

An example Method for Exploring a Patient Record is illustrated in FIG. 4 which presents how the system may implement different patient exploration runtime use cases, as a clinician explores patient information, searching for focused answers. Three example implementations I-III on the referenced use cases are now described:
I. Ask Question: FIG. 5 presents how the system may implement the use case in which the clinician asks a question.
II. Search In Patient Record: FIG. 6 presents how the system may implement a use case in which clinicians search through a patient record.
III. Follow Exploration Topic Suggestions: FIG. 7 presents how the system may implement a use case in which clinicians select a specific exploration topic and view it.

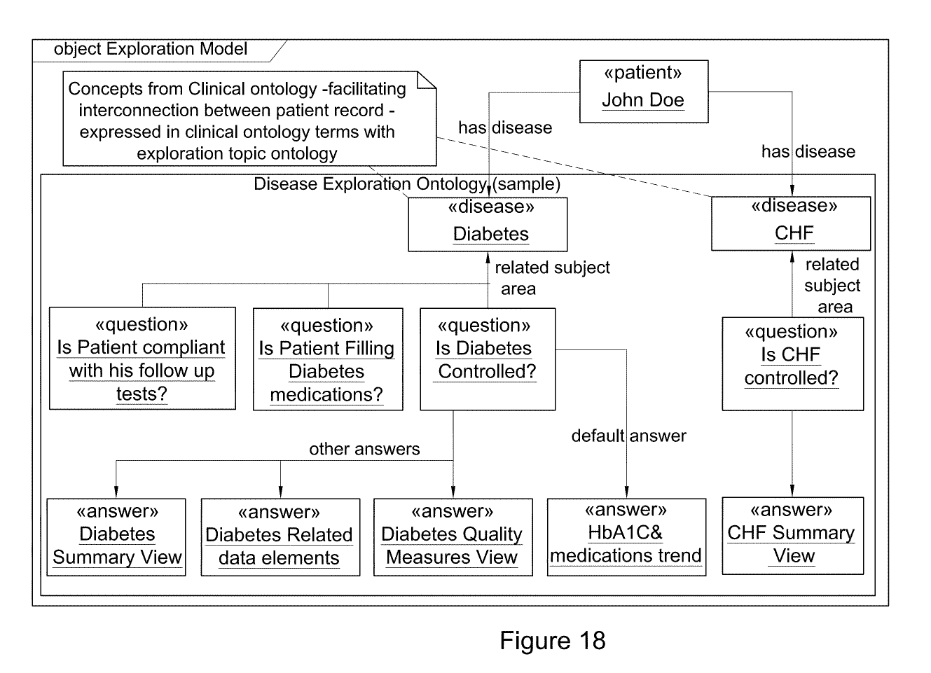

FIG. 18 presents how the system may deduce further exploration topics (question and answers, in the illustrated embodiment) navigating from one topic or question to other questions related to the patient. This may be achieved by x-referencing (cross-referencing) a patient's codified clinical data, translated into ontological concepts, with exploration topic ontology which may include ontological concepts as well. Two example methods for effecting this are now described with reference to FIG. 18:

a. Different questions (suggested data requests) from the same subject area (or disease) can be considered as siblings in the ontology. For example “Is Diabetes controlled?” and “Is patient compliant with his follow up meds?”

b. Re different questions (suggested data requests) from different subject area (or disease) with similar meaning, these may be correlated through patient data. For example “Is Diabetes controlled?” and “Is CHF controlled?”

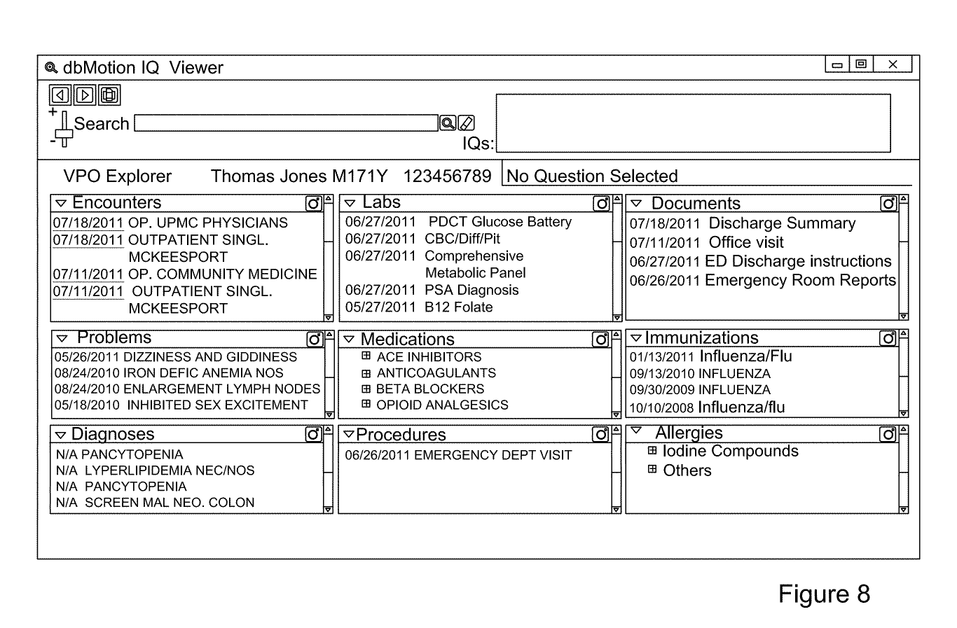

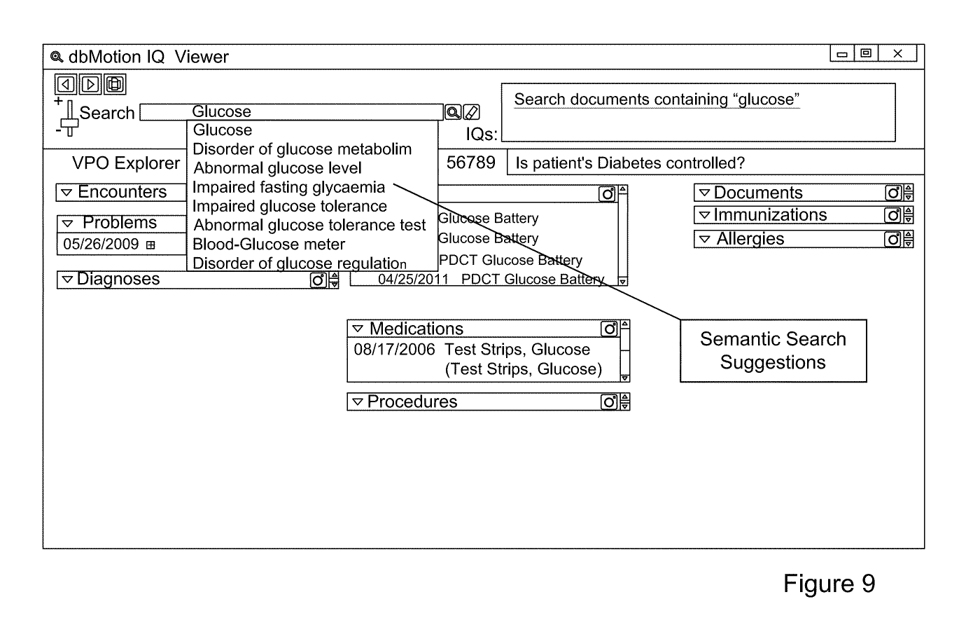

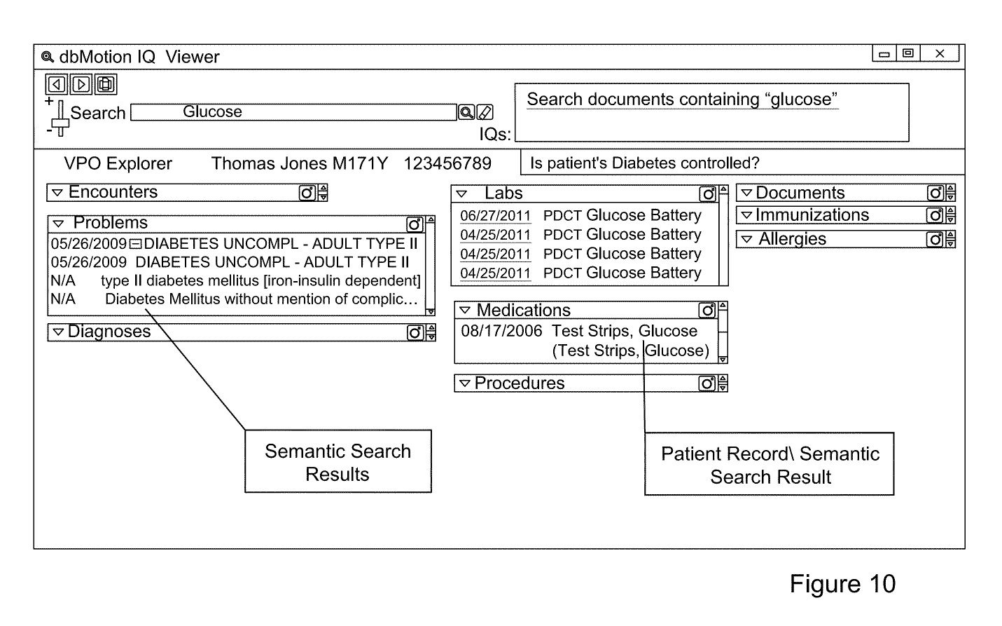

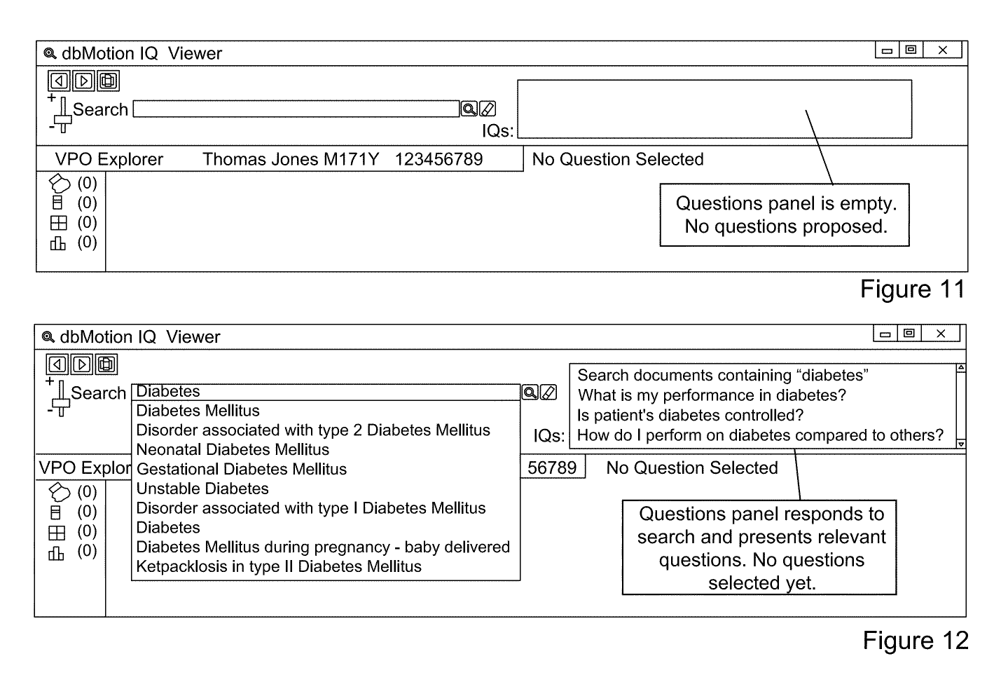

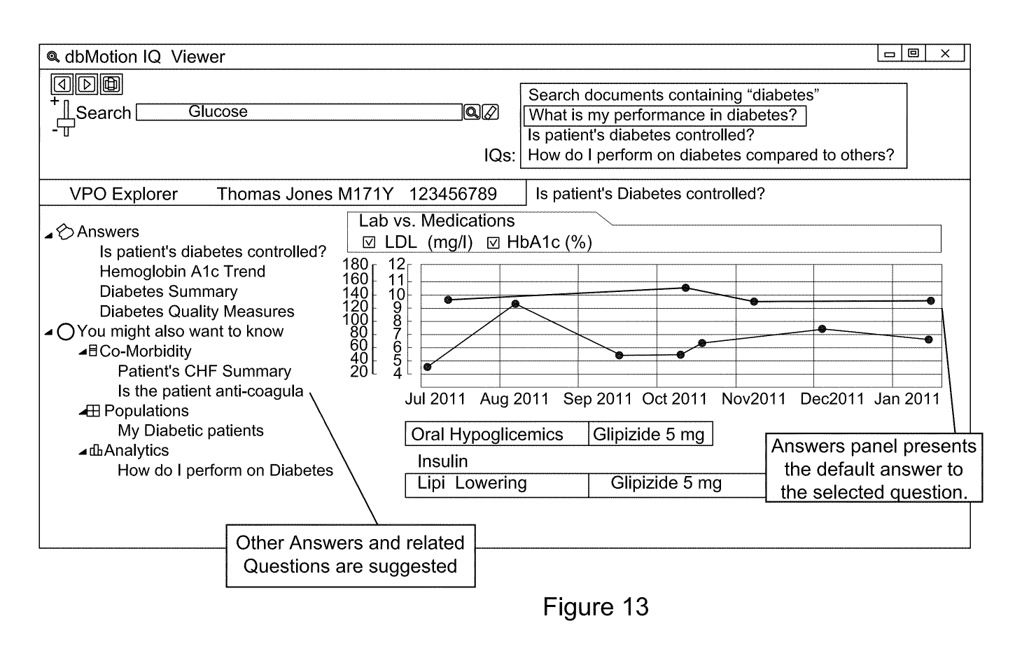

Functionalities A, B of the system, one or both of which may be provided according to certain embodiments, are best appreciated with reference to the following example screen shots:
A. Effect of Search in VPO Explorer: FIGS. 8-10, of which:
FIG. 8 illustrates VPO Explorer Mode with No search topics
FIG. 9 illustrates VPO Explorer Mode with User types, Suggestions Appear
FIG. 10 illustrates VPO Explorer Mode with Filtered patient record.
B. Questions and answers: FIGS. 11-13, of which:
FIG. 11 illustrates Question Mode with No Search
FIG. 12 illustrates Questions Mode where Relevant Questions Appear, with No Question Selected
FIG. 13 illustrates Questions Mode with Question Selected and Answer Presented.

Other embodiments, including search packages, which may be provided alternatively or in addition, are now described.

An increasing problem in healthcare IT is the “too much information” syndrome, in which clinicians are flooded with an immense amount of bits and pieces of information. As HIE advances, the amount of available patient information increases. Conventional dbMotion software solutions for this problem include semantic grouping—which organizes the data according to its semantic meaning and delta view—in which only data that is not elsewhere available to the user is presented. Another solution to be provided alternatively or in addition is now described in detail. As part of this effort, software may be provided which allows clinicians to search within the patient record freely. However, searching as described herein may be useful in other areas of use as well, such as semantic content management, analytics, search for clinical trials candidates and more.

By way of example, an open source search engine called Lucene may optionally be integrated. This is a java project ported to .Net while keeping common file structure. Suitable scoring algorithms include some or all of the following teachings provided by Lucene, in the following section in italics:

```
  “Lucene scoring is ...blazingly fast and it hides almost all of the complexity from the
user. In a nutshell, it works. At least, that is, until it doesn't work, or doesn't work as one would
expect it to work. Then we are left digging into Lucene internals or asking for help on java-
user@lucene.apache.org to figure out why a document with five of our query terms scores lower
than a different document with only one of the query terms.
While this document won't answer your specific scoring issues, it will, hopefully, point you to
the places that can help you figure out the what and why of Lucene scoring.
Lucene scoring uses a combination of the Vector Space Model (VSM) of Information Retrieval
(IR) and the Boolean model to determine how relevant a given Document is to a User's query.
In general, the idea behind the VSM is the more times a query term appears in a document
relative to the number of times the term appears in all the documents in the collection, the more
relevant that document is to the query. It uses the Boolean model to first narrow down the
documents that need to be scored based on the use of boolean logic in the Query specification.
Lucene also adds some capabilities and refinements onto this model to support boolean and
fuzzy searching, but it essentially remains a VSM based system at the heart. For some valuable
references on VSM and IR in general refer to the Lucene Wiki IR references.
  The rest of this document will cover Scoring basics and how to change your Similarity.
Next it will cover ways you can customize the Lucene internals in Changing your Scoring --
Expert Level which gives details on implementing your own Query class and related
functionality. Finally, we will finish up with some reference material in the Appendix.
  Scoring: Scoring is very much dependent on the way documents are indexed, so it is
important to understand indexing (see Apache Lucene - Getting Started Guide and the Lucene
file formats before continuing on with this section.) It is also assumed that readers know how to
use the Searcher.explain(Query query, int doc) functionality, which can go a long way in
informing why a score is returned.
  Fields and Documents: In Lucene, the objects we are scoring are Documents. A
Document is a collection of Fields. Each Field has semantics about how it is created and stored
(i.e. tokenized, untokenized, raw data, compressed, etc.) It is important to note that Lucene
scoring works on Fields and then combines the results to return Documents. This is important
because two Documents with the exact same content, but one having the content in two Fields
and the other in one Field will return different scores for the same query due to length
normalization (assumming the DefaultSimilarity on the Fields).
  Score Boosting: Lucene allows influencing search results by “boosting” in more than one
level:
•Document level boosting - while indexing - by calling document.setBoost( ) before a document
is added to the index.
•Document's Field level boosting - while indexing - by calling field.setBoost( ) before adding a
field to the document (and before adding the document to the index).
•Query level boosting - during search, by setting a boost on a query clause, calling
Query.setBoost( ).
Indexing time boosts are preprocessed for storage efficiency and written to the directory (when
writing the document) in a single byte (!) as follows: For each field of a document, all boosts of
that field (i.e. all boosts under the same field name in that doc) are multiplied. The result is
multiplied by the boost of the document, and also multiplied by a “field length norm” value that
represents the length of that field in that doc (so shorter fields are automatically boosted up).
The result is decoded as a single byte (with some precision loss of course) and stored in the
directory. The similarity object in effect at indexing computes the length-norm of the field.
  This composition of 1-byte representation of norms (that is, indexing time multiplication
of field boosts & doc boost & field-length-norm) is nicely described in Fieldable.setBoost( ).
Encoding and decoding of the resulted float norm in a single byte are done by the static methods
of the class Similarity: encodeNorm( ) and decodeNorm( ). Due to loss of precision, it is not
guaranteed that decode(encode(x)) = x, e.g. decode(encode(0.89)) = 0.75. At scoring (search)
time, this norm is brought into the score of document as norm(t, d), as shown by the formula in
Similarity.
  Understanding the Scoring Formula: This scoring formula is described in the Similarity
class. Please take the time to study this formula, as it contains much of the information about
how the basics of Lucene scoring work, especially the TermQuery.
The Big Picture: OK, so the tf-idf formula and the Similarity is great for understanding the
basics of Lucene scoring, but what really drives Lucene scoring are the use and interactions
between the Query classes, as created by each application in response to a user's information
need.
  In this regard, Lucene offers a wide variety of Query implementations, most of which are
in the org.apache.lucene.search package. These implementations can be combined in a wide
variety of ways to provide complex querying capabilities along with information about where
matches took place in the document collection. The Query section below highlights some of the
more important Query classes. For information on the other ones, see the package summary.
For details on implementing your own Query class, see Changing your Scoring -- Expert Level
below.
  Once a Query has been created and submitted to the IndexSearcher, the scoring process
begins. (See the Appendix Algorithm section for more notes on the process.) After some
infrastructure setup, control finally passes to the Weight implementation and its Scorer instance.
In the case of any type of Boolean Query, scoring is handled by the BooleanWeight2 (link goes
to ViewVC BooleanQuery java code which contains the BooleanWeight2 inner class) or
BooleanWeight (link goes to ViewVC BooleanQuery java code, which contains the
BooleanWeight inner class).
  Assuming the use of the BooleanWeight2, a BooleanScorer2 is created by bringing
together all of the Scorers from the sub-clauses of the Boolean Query. When the BooleanScorer2
is asked to score it delegates its work to an internal Scorer based on the type of clauses in the
Query. This internal Scorer essentially loops over the sub scorers and sums the scores provided
by each scorer while factoring in the coord( ) score.
Query Classes: For information on the Query Classes, refer to the search package javadocs
Changing Similarity: One of the ways of changing the scoring characteristics of Lucene is to
change the similarity factors. For information on how to do this, see the search package
javadocs
Changing your Scoring -- Expert Level: At a much deeper level, one can affect scoring by
implementing their own Query classes (and related scoring classes.) To learn more about how
to do this, refer to the search package javadocs
Appendix
Algorithm: This section is mostly notes on stepping through the Scoring process and serves as
fertilizer for the earlier sections.
In the typical search application, a Query is passed to the Searcher , beginning the scoring
process.
Once inside the Searcher, a Collector is used for the scoring and sorting of the search results.
These important objects are involved in a search:
1.The Weight object of the Query. The Weight object is an internal representation of the Query
that allows the Query to be reused by the Searcher.
2.The Searcher that initiated the call.
3.A Filter for limiting the result set. Note, the Filter may be null.
4.A Sort object for specifying how to sort the results if the standard score based sort method is
not desired.
Assuming we are not sorting (since sorting doesn't effect the raw Lucene score), we call one of
the search methods of the Searcher, passing in the Weight object created by
Searcher.createWeight(Query), Filter and the number of results we want. This method returns a
TopDocs object, which is an internal collection of search results. The Searcher creates a
TopScoreDocCollector and passes it along with the Weight, Filter to another expert search
method (for more on the Collector mechanism, see Searcher .) The TopDocCollector uses a
PriorityQueue to collect the top results for the search.
If a Filter is being used, some initial setup is done to determine which docs to include.
Otherwise, we ask the Weight for a Scorer for the IndexReader of the current searcher and we
proceed by calling the score method on the Scorer.
At last, we are actually going to score some documents. The score method takes in the Collector
(most likely the TopScoreDocCollector or TopFieldCollector) and does its business. Of course,
here is where things get involved. The Scorer that is returned by the Weight object depends on
what type of Query was submitted. In most real world applications with multiple query terms,
the Scorer is going to be a BooleanScorer2 (see the section on customizing your scoring for info
on changing this.)
Assuming a BooleanScorer2 scorer, we first initialize the Coordinator, which is used to apply
the coord( ) factor. We then get a internal Scorer based on the required, optional and prohibited
parts of the query. Using this internal Scorer, the BooleanScorer2 then proceeds into a while
loop based on the Scorer#next( ) method. The next( ) method advances to the next document
matching the query. This is an abstract method in the Scorer class and is thus overriden by all
derived implementations. If you have a simple OR query your internal Scorer is most likely a
DisjunctionSumScorer, which essentially combines the scorers from the sub scorers of the OR'd
terms.”
The factors involved in Lucene's scoring algorithm may be some or all of the following, again as
described by Lucene: “
  1. tf = term frequency in document = measure of how often a term appears in the
    document
  2. idf = inverse document frequency = measure of how often the term appears
    across the index
  3. coord = number of terms in the query that were found in the document
  4. lengthNorm = measure of the importance of a term according to the total number
    of terms in the field
  5. queryNorm = normalization factor so that queries can be compared
  6. boost (index) = boost of the field at index-time
  7. boost (query) = boost of the field at query-time
The implementation, implication and rationales of factors 1,2, 3 and 4 in DefaultSimilarity.java,
which is what you get if you don't explicitly specify a similarity, are:
Note: the implication of these factors should be read as, “Everything else being equal, ...
[implication] ”
1. tf
Implementation: sqrt(freq)
Implication: the more frequent a term occurs in a document, the greater its score
Rationale: documents which contains more of a term are generally more relevant
2. idf
Implementation: log(numDocs/(docFreq+1)) + 1
Implication: the greater the occurrence of a term in different documents, the lower its score
Rationale: common terms are less important than uncommon ones
3. coord
Implementation: overlap / maxOverlap
Implication: of the terms in the query, a document that contains more terms will have a higher
score
Rationale: self-explanatory
4. lengthNorm
Implementation: 1/sqrt(numTerms)
Rationale: a term in a field with less terms is more important than one with more
queryNorm is not related to the relevance of the document, but rather tries to make scores
between different queries comparable. It is implemented as 1/sqrt(sumOfSquaredWeights)
So, in summary (quoting Mark Harwood from the mailing list),
* Documents containing *all* the search terms are good
* Matches on rare words are better than for common words
* Long documents are not as good as short ones
* Documents which mention the search terms many times are good
The mathematical definition of the scoring can be found at [the following http link:
lucene.apache.org/java/2_9_1/api/core/org/apache/lucene/search/Similarity.html
Hint: look at NutchSimilarity in Nutch to see an example of how web pages can be scored for
relevance
Customizing scoring: To customize the scoring algorithm, just subclass DefaultSimilarity and
override the method you want to customize.
For example, if you want to ignore how common a term appears across the index,
Similarity sim = new DefaultSimilarity( ) {
public float idf(int i, int i1) {
return 1;
}
}
and if you think for the title field, more terms is better
Similarity sim new DefaultSimilarity( ) {
public float lengthNorm(String field, int numTerms) {
if(field.equals(“title”)) return (float) (0.1 * Math.log(numTerms));
else return super.lengthNorm(field, numTerms);
}
}
“.
```

Boosting may be used in the Lucene technology, e.g. as described at the following http location: lucene.apache.org/core/old_versioned_docs/versions/3_{—}0_{—}2/scoring.html.

Boosting is an operation which modifies search scoring and may comprise one of both of:
1. Index-time. Boosting an element means that element is better\“more important” than other elements, without taking the query (“the search term”) into account. Typically, what one needs to know:
   A boost is assigned to each searchable element (e.g. “document” in Lucene”)
   The index is re-created to change the boost. At least the element has to be indexed again.
   Each field can be boosted separately.
2. Query-time. In essence here the adaptation applies to the search terms the user entered. It includes:
   Similarity—i.e. tolerance to typos (number in the (0-1) range) Field boost—differentiate which field is more important, for example “designation” field receives higher weight than “synonyms” field.

The Lucene package, or a similar package, may be used in some or all of the following several separate search libraries:
A. Semantic Search—Searches within a clinical ontology, such as dbMotion ontology, for clinical terms. The search results can have numerous usages, including applying them on a computerized e.g. digital patient record (or Virtual Patient Object—VPO)—leaving in only records whose clinical code are considered equal to the search results or one of its descendants (in an ontology). The term “Considered equal” refers to a concept in an ontology that has been mapped to another concept.
B. VPO Search—Indexes a single patient record—a VPO—on the fly, or ahead of time, and allow searching in it based on different properties
C. Disease Exploration Topics Search—such as questions and answers. This package allows to search in the disease exploration ontology knowledge base
D. Optional: Document Search which provides full-text search within patient clinical documents, with or without using semantic information as enabler for synonym expansion.

The combination of VPO search and semantic search allows a user-clinician to quickly locate relevant information in the patient file. This functionality may easily be integrated into clinical applications such as but not limited to one some or all of the following commercially available dbMotion clinical applications: dbMotion EHR Agent, dbMotion Questions And Answers application, dbMotion Clinical Viewer.

Certain embodiments of the above search libraries A-C are described in detail below:

### A. Semantic Search:

Typically, this package allows to search within a suitable ontology e.g. dbMotion ontology. In this case, typically, indexing is done offline, whenever the ontology changes for example—on a new product release, updates to the ontology or after mapping effort completion. The applications may get a ready-to-use search index and a library that knows how to read the search index and provides a simple-to-use search interface.

It is desired to capitalize on the ontology properties to come up with a good search result e.g. using a combined strategy of, say, indexing-time boosting and search-time boosting and-or query time boosting, e.g. as described above.

In addition, utilization of the ontology may include utilization of concept relationships such as a “may treat” relationship between “diabetes mellitus” problem and “diabetic medications”. In that example, diabetic medications in all its forms typically are served up as semantic search results for “diabetes”. Another capability is to search by mapped concepts.

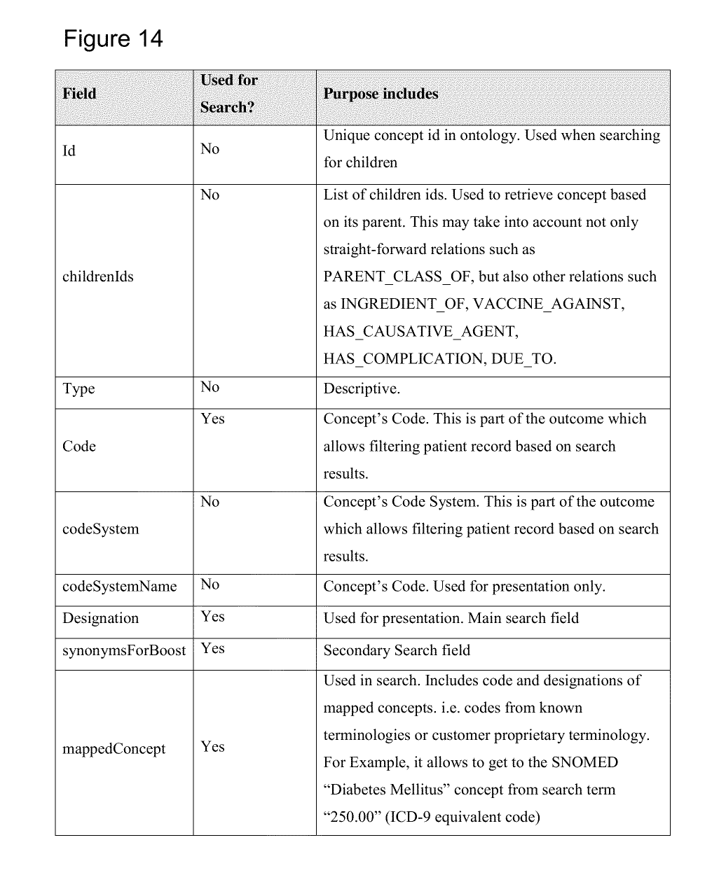

Index Structure: Each element in the index may include an ontology concept. The table of FIG. 14 presents possible semantic search index fields, some or all of which may be provided.

Indexing process: As mentioned above, this process typically does not occur at runtime, but rather is prepared ahead of time. This process is performed e.g. against a validated clinical ontology. The input may include a set of root concepts (all descendants of the concept may be added) or code systems (all concepts of that code system). The process typically retrieves each concept's details, including its relations, and builds, say, a Lucene document to add to the index. As part of this process—the mapped concepts are typically also retrieved. This may be where the index-time boosting factors take place. It then adds all the concepts\documents into the index and then commits and optimizes it.
Search process: This is a runtime process in which a user writes down search terms which are looked up in a pre-defined index. The process typically adds on query-time boost factors on top of the index-time factors, already integrated into the index to yield search results. The outcome of this process typically comprises an ordered list of terms that fit the search term, including, say, some or all of the terms' code and code system and/or designation.
Index Time Boosting Factors: Typically operative to reflect the ontology properties into an index-time boost, so as to take into account some or all of the following:
1. Concept usage\popularity. The more the concept is used—the better is its score.
2. Code system. Each code system may be assigned a boost factor
3. Concept Type—e.g. RxNorm type BN (Branded Ingredients) deserves a boost up.
4. Ontology Graph structure—how many children does the concept have? How many parents does the concept have?
5. Number of direct mapped concepts the concept has.
   The Formulas below are example formulae which may be used to determine the final index-time boost of the concept:

Let
Ctitb be Concept Total Index-Time Boost,
Csb be Code System boost, defined by config
Ctb be Concept type boost.
Cmb be concept mapping boost. Values are in the range 0,1.
Cglb be concept graph location boost. Values are in the range 0,1.
Cub be concept usage boost future, currently set to 0.
Values are in the range 0,1.
And α,β, γ are the respective boosting factors
Then: Ctitb=Csb X CtbX(1+αCglb+βCmb+γCub) (formula i)

The elements in the above are defined by the following formulae ii-v:

```
formula ii: Cglb=ChildrenBonus(concept)ParentPenalty(Concept)
formula iii:Parent Penaltyconcept
=fminparent countdirect parent count, , MAX_PARENT_RATIOfMAX_PARENT_RATIO
      where fx=ln1+x, MAX_PARENT_RATIO =10
              formula iv:
          ChildrenBonusconcept=fmin(#children,
  MAX_EFFECTIVE_CHILDEREN)f(MAX_EFFECTIVE_CHILDEREN)
    where fx=x0.75, MAX_EFFECTIVE_CHILDEREN=50;
            fxcould also be sqrt(x) or ln1+x,
----------
formula v:
Cmb=0 , cdm≦112+12x CdmMdm, 1<Cdm<Mdm1 ,
Mdm≦Cdm
Where:
Mdm is the maximum mapping count we want to bonus. Example default value is 5.
Cdm is the concepts actual mapping count
```

The reason that mapping count of 1 is typically not bonused is that all ontology has at least one mapping out of the box—the terminology that came from e.g. ontology code that originated from SNOMED, has a mapping relation to the SNOMED terminology concept.
Query Time Boosting Factors: Typically, query time factors are taken into consideration e.g. by transforming the search string into Lucene query. Lucene does the rest—taking into account, among others, term frequency (how many terms are searched affects the importance of each one) and/or Term Document Frequency (how many documents include each of the terms—making it less distinctive from search perspective).
Stop words—Keyword Removal: Keywords such as AND, OR, NOT which are part of Lucene query language are typically taken out of the search string in order to avoid confusion.
Operator: A suitable selection in this case is the AND operator, in which case all terms (with exception of last term—see below wild card section) are to be included in the searched concepts.
Similarity: The Lucene Similarity feature enables Lucene documents (concepts e.g.) to be found even if mistyped by a user. This parameter is typically selected to balance between false positives against false negatives. Similarity is a number in the range (0,1). The similarity can be altered, by default it is set to a suitable value, say, 0.8 which seem to provide a good trade off.
User still typing—Wild Card for last term: Typically, the underlining assumption of the semantic search is the user is still typing. For that reason, the last term (assuming no spaces at the end) is used for wild card search. Other terms are not treated this way. This may cause different search results when searching with or without space at the end of the search string. However, It is possible that user has completed writing the last term and so the last term “fox” will be transformed into “(fox OR fox*). One last point is about similarity. Similarity cannot be applied together with wildcard, so the last term receives similarity only on the left-hand side of the OR clause.
Transformation Example: The term “The big fox” is converted to “the˜0.8 AND big˜0.8 AND (fox˜0.8 OR fox*)
However with whitespace:
“The big fox” is converted to “the˜0.8 AND big˜0.8 AND fox˜0.8
End Results of Semantic Search A may include some or all of:
Search Suggestion: The top N concepts can be suggested to the user as auto-complete suggestions; and/or
Concepts as Filters: Since, typically, the search result contains not only the concept, but also all of its derived concepts, (e.g. “Diabetes Mellitus type 2” is derived from “Diabetes Mellitus”) the search result is easily turned into a powerful filter over codified data. This may be a single patient record, BI tool or some other application that is aware of the ontology or its mapped terminologies.

### B. VPO/Patient Record Search:

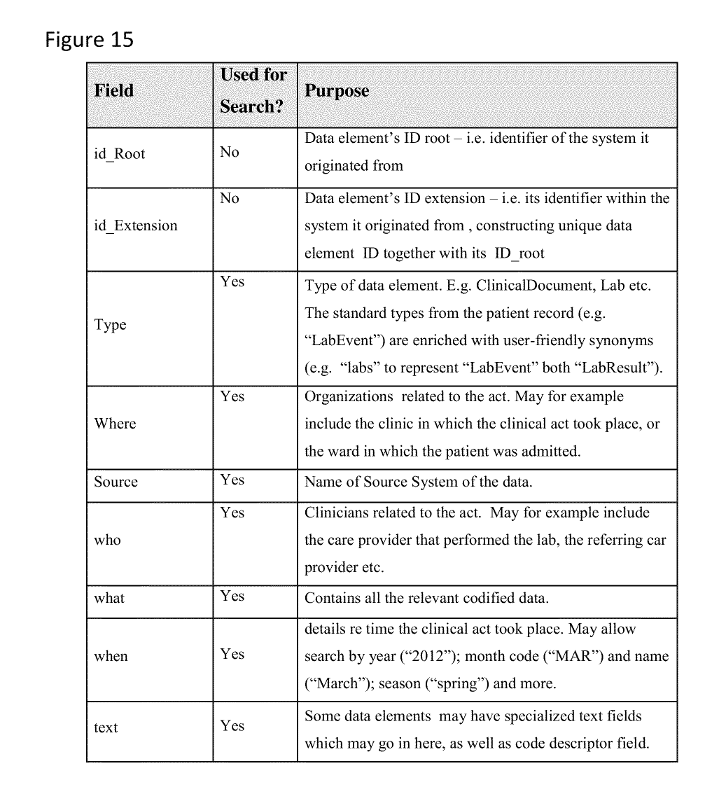

This package allows to search within a VPO—e.g. dbMotion's patient record, or similar dataset. In this case, indexing is typically done on the fly. The outcome of the search typically includes a list of references to data elements that fit the search terms. The index is typically never stored anywhere, it is kept in memory until moving to the next patient. An example Index Structure, some or all of which may be provided, is shown in FIG. 15. Indexing process typically happens on the fly when entering a new patient file.
Search process: Similarly to the semantic search description herein—this is typically a runtime process in which user writes down search terms which are looked up in a pre-defined index. The runtime process typically adds on query-time boost factors on top of the index-time factors, already integrated into the index to yield search results. However, the outcome here typically includes an ordered list (by relevance) of references to acts (or data elements) that meet the search criteria.

Index time Boosting Factors are typically N/A for this case, typically. Query Time Boosting Factors are typically same as for Semantic Search A as described above.

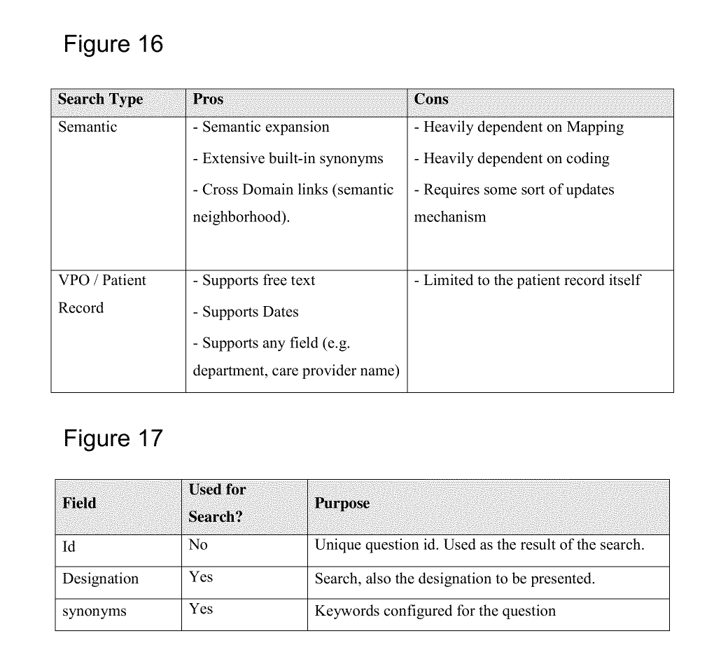

Semantic and VPO Searches A and B may if desired be combined, e.g. because the two approaches may provide different advantages and different “blind spots” e.g. some or all of those presented in the table of FIG. 16.
As is apparent from the table of FIG. 16, a hybrid solution may be provided, in which the filter eventually applied to the patient record (VPO) uses the superset of the search mechanisms. The patient record search typically employs a union between the semantic-results-filter results and the patient-record-search results. Any act (e.g. data element) that has been found by either one of the two methods is typically presented as a search result.
   C. Disease Exploration Topics (e.g. Questions, Answers):

This may include a simplified version of the semantic search operative to read a set of questions and index them thereby to facilitate search for the set. The index is built on the fly and may include some or all of the Index Structure shown in FIG. 17. Indexing process typically happens on the fly when opening the application and could be effected by a user change process as well. Search process: Similarly to semantic search A, described above, this type comprises a runtime process in which user writes down search terms which are looked up in the pre-prepared index. The Search process typically adds on query-time boost factors on top of the index-time factors, already integrated into the index to yield search results. However, the outcome here typically comprises an ordered list (by relevance) of questions that best met the search criteria.

As part of the questions model, different index time boosting factors may be defined for different questions. Query Time Boosting Factors may be similar to those described above for Semantic Search A.

Table-cells, rows and columns, which are presented for brevity in the context of a single table may be provided separately or in any suitable subcombination or in a different order.

The methods shown and described herein are particularly useful in retrieving, viewing, processing, analyzing, sorting or searching bodies of knowledge including hundreds, thousands, tens of thousands, or hundreds of thousands of electronic medical records or other computerized information repositories. This is because practically speaking, such large bodies of knowledge can only be processed, analyzed, sorted, or searched using computerized technology.

The system may if desired be implemented as a web-based system employing software, computers, routers and telecommunications equipment as appropriate.

The methods and systems shown and described herein may be applicable to health system IT formats which are not identical to those specifically mentioned herein e.g. dBMotion and SNOMED, but have relevant features in common therewith.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer usable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A method for facilitating clinician-user navigation through a computerized medical information repository including utilizing a clinically ontological hierarchy of clinical semantic elements, the method comprising:
generating an ontology of suggested data requests defined in terms of said ontological hierarchy of clinical semantic elements; and
Responsive to an individual clinician-user's navigation through the medical information repository, presenting suggested data requests to the clinician-user based on pre-defined rules defined over the ontology of suggested data requests.

2. A method according to claim 1 and also comprising:
Responsive to an individual clinician-user's navigation through the medical information repository, thereby to define a current user location disposed within the medical information repository and pertaining to at least one individual related element within said clinically ontological hierarchy of clinical semantic elements:
from among a multiplicity of suggested data requests, selecting at least one individual suggested data request which is defined in terms of an ancestor of an individual son-element within said clinically ontological hierarchy of clinical semantic elements,
plugging medical information pertaining to said individual son-element into said suggested data request thereby to generate a son-specific suggested data request, and
presenting the son-specific suggested data request to the clinician-user, and
Responsive to a clinician-user's selection of an individual son-specific suggested data request from among those presented: presenting, to the clinician user, at least one response to said individual son-specific suggested data request.

3. A method according to claim 2 and also comprising, responsive to a clinician-user's selection of an individual son-specific suggested data request from among those presented, plugging individual medical information pertaining to an additional son-element of said ancestor into said individual suggested data request thereby to generate at least one additional son-specific suggested data request instance, and presenting the additional son-specific suggested data request instance to the clinician-user.

4. A method according to claim 3 wherein the current user location is located within an individual patient record within the computerized medical information repository and wherein the additional son-element is selected to be a son-element which is defined for said ancestor within said individual patient record.

5. A method according to claim 1 wherein, responsive to the individual clinician-user's selection of said individual suggested data request, a plurality of responses to said individual suggested data request are presented to the clinician user corresponding to a plurality of pre-defined response formats respectively.

6. A method according to claim 5 and also comprising:
Receiving the individual clinician-user's selection of an individual response, from among the plurality of responses, which is formatted according to an individual response format from among the plurality of pre-defined response formats; and
learning the individual clinician-user's expected response to at least one suggested data request including: upon future selection by the individual clinician-user, of a suggested data request instance of the same individual suggested data request, prioritizing presentation of a response formatted according to the individual response format previously selected by the individual clinician-user, over presentation of responses formatted according to response formats other than the individual response format previously selected by the individual clinician-user.

7. A method according to claim 1 and also comprising:
Pre-generating a multiplicity of suggested data requests; and
Pre-generating responses including at least one response for each of the multiplicity of suggested data requests respectively.

8. A method according to claim 7 and wherein said presenting comprises:
Responsive to an individual clinician-user's navigation through the medical information repository:
selecting at least one individual suggested data request from among the multiplicity of suggested data requests for presentation to the clinician user; and
presenting, to the clinician user, a plurality of responses to said individual suggested data request corresponding to a plurality of pre-defined response formats respectively;
Receiving the individual clinician-user's selection of an individual response, from among the plurality of responses, which is formatted according to an individual response format from among the plurality of pre-defined response formats; and
learning the individual clinician-user's expected response to the at least one suggested data request including: upon future selection by the individual clinician-user, of a suggested data request instance of the same individual suggested data request, prioritizing presentation of a response formatted according to the individual response format previously selected by the individual clinician-user, over presentation of responses formatted according to response formats other than the individual response format previously selected by the individual clinician-user.

9. A method according to claim 2 and also comprising Pre-generating the multiplicity of suggested data requests.

10. A method according to claim 9 and also comprising pre-generating responses including at least one response for each of the multiplicity of suggested data requests respectively.

11. A method according to claim 1 wherein the clinically ontological hierarchy of elements includes at least one of:
a SNOMED-based clinically ontological hierarchy of clinical semantic elements;
a LOINC-based clinically ontological hierarchy of clinical semantic elements;
an RxNorm-based clinically ontological hierarchy of clinical semantic elements; and
an NDC-based clinically ontological hierarchy of clinical semantic elements.

12. A method according to claim 7 wherein said pre-generating is characterized to facilitate:
responsive to an individual clinician-user's navigation through the medical information repository, thereby to define a current user location disposed within the medical information repository and pertaining to at least one individual son-element within said clinically ontological hierarchy of clinical semantic elements:
Selection of at least one individual suggested data request from among the multiplicity of suggested data requests which is defined in terms of an ancestor of said son-element within said clinically ontological hierarchy of clinical semantic elements,
Plugging of medical information pertaining to said individual son-element into said suggested data request thereby to generate a son-specific suggested data request, and
Presentation of the son-specific suggested data request to the clinician-user.

13. A method according to claim 12 wherein said pre-generating is also characterized to facilitate, responsive to a clinician-user's selection of an individual son-specific suggested data request from among those presented:
presentation, to the clinician user, at least one response to said individual son-specific suggested data request.

14. A method according to claim 1 wherein said ontology of suggested data requests is also defined so as to ontologically relate data requests pertaining to aspects of patient compliance even if the ontological hierarchy of clinical semantic elements does not ontologically relate clinical semantic elements pertaining to patient compliance.

15. A method according to claim 1 wherein said ontology of suggested data requests is also defined so as to ontologically relate data requests pertaining to aspects of patient life-style even if the ontological hierarchy of clinical semantic elements does not ontologically relate clinical semantic elements pertaining to patient life-style.

16. A computerized system for facilitating clinician-user navigation through a computerized medical information repository including utilizing a clinically ontological hierarchy of clinical semantic elements, the system comprising:
a computerized ontology of suggested data requests defined in terms of said ontological hierarchy of clinical semantic elements; and
a processor operative, responsive to an individual clinician-user's navigation through the medical information repository, for presenting suggested data requests to the clinician-user based on pre-defined rules defined over the ontology of suggested data requests.

17. A computer program product, comprising a non-transitory tangible computer readable medium having computer readable program code embodied therein, said computer readable program code adapted to be executed to implement a method for facilitating clinician-user navigation through a computerized medical information repository including utilizing a clinically ontological hierarchy of clinical semantic elements, the method comprising:
generating an ontology of suggested data requests defined in terms of said ontological hierarchy of clinical semantic elements; and
Responsive to an individual clinician-user's navigation through the medical information repository, presenting suggested data requests to the clinician-user based on pre-defined rules defined over the ontology of suggested data requests.

18. A system according to claim 16 wherein, responsive to the individual clinician-user's selection of said individual suggested data request, the processor is operative for presenting a plurality of responses to said individual suggested data request to the clinician user corresponding to a plurality of pre-defined response formats respectively.

19. A system according to claim 16 wherein said ontology of suggested data requests is also defined so as to ontologically relate data requests pertaining to aspects of patient compliance even if the ontological hierarchy of clinical semantic elements does not ontologically relate clinical semantic elements pertaining to patient compliance.

20. A system according to claim 16 wherein said ontology of suggested data requests is also defined so as to ontologically relate data requests pertaining to aspects of patient life-style even if the ontological hierarchy of clinical semantic elements does not ontologically relate clinical semantic elements pertaining to patient life-style.
